(19) United States
(12) Patent Application Publication
(10) Pub. No.: US 2021/0187629 A1
(43) Pub. Date: Jun. 24, 2021

(54) Method for detecting connecting elements, in particular friction drilling screws, in mechanical joining and forming processes in which an error event in the process was identified

(71) Applicant: Atlas Copco IAS GmbH, Bretten-Gölshausen (DE)

(72) Inventors: Frederic Hervouet, Avrillé (FR); Sebastien Clauss, Haguenau (FR); Alexander Raab, Geretsried (DE)

(73) Assignee: Atlas Copco IAS GmbH, Bretten-Gölshausen (DE)

(21) Appl. No.: 16/953,136

(22) Filed: Nov. 19, 2020

(30) Foreign Application Priority Data
Dec. 19, 2019 (DE) 102019135273.8

(51) Int. Cl. B23B 49/00

(52) U.S. Cl. CPC B23B 49/001

(57) ABSTRACT

Methods and devices are provided for detecting connecting elements, in particular friction drilling screws, in mechanical joining and forming processes in which an error event in the process was identified. The method includes moving a carrier component for the connecting element toward a workpiece to determine a contact point of the connecting element on the workpiece. This feeding step is carried out as a next method step after the error event is detected and ascertains whether the contact point is detected within a predefined permissible tolerance in order to determine whether the connecting element is still located in a feed head.

### TECHNICAL FIELD OF THE INVENTION

The invention relates to a method for detecting connecting elements, in particular friction drilling screws, in mechanical joining and forming processes in which an error event (NOK event) in the process was identified before or up to a small penetration of the connecting element, as well as a device for carrying out such a method.

### BACKGROUND OF THE INVENTION

Mechanical joining or forming methods and thus cold methods, such as in particular friction drilling, are used for example in automotive engineering when screwing together workpieces, wherein workpieces are connected directly by means of friction drilling.

In friction drilling, the first process stage passed through is usually “finding the contact point of the screw” as the screw retained on a feed head is moved toward the workpiece, wherein this stage can also comprise locating a contact point of a downholder for securing the workpieces. As used in this disclosure and the accompanying claims, the “contact point” of a respective element in a mechanical joining or forming process means the point along the course of movement of that element at which the element makes contact with the workpiece.

The second process stage passed through is the so-called “extruded hole formation”, in which the screw penetrates into the workpiece, before thread forming and subsequent final tightening with the screw head meeting the surface are effected in further process steps with corresponding control of the rotational speed and the forward speed.

The required parameters, such as feed force, feed travel (of the downholder and/or feed head or component thereof adapted to advance the screw to the workpiece), rotational speed (of the shaft adapted to drive the screw), torque, penetration depth and maximum time, are usually monitored here in order to guarantee a process within permissible tolerances.

If in the first two process stages or process steps of “finding” and “extruded hole formation” an error is identified (e.g. downholder travel and/or screw carrying component travel outside a prespecified tolerance, permissible torque exceeded or required torque not achieved), in the event of such an error (“NOK event” Not OK event) it is not known (and also cannot be detected) whether or not a screw is still located in the feed head.

Thus, when an NOK event is confirmed, an ejection stroke is in any case run first of all in order to ensure that a screw is no longer located in the feed head. Then a loading stroke is run and a new screw is loaded.

Hereafter it has to be decided whether the process can be repeated at the present location or machining point, or whether the process equipment (e.g. robot) moves to the next process point (intended machining point) due to non-repeatability.

Consequently, screws can disadvantageously be left behind in the equipment area. Moreover, the known machining process is time-consuming.

### SUMMARY OF THE INVENTION

An object of the present invention is therefore to provide a method and a device for carrying out the method, to avoid the present disadvantages in mechanical joining and forming processes, in particular screws or other connecting elements being left behind in the equipment area, and at the same time to guarantee a rapid machining process.

According to an aspect of the invention, if an error occurs and is identified in the mechanical joining or forming process (NOK event), for example if the maximum permissible torque on a screw driving component is exceeded or the torque falls below the permissible minimum, it is determined whether a connecting element is still located in the feed head.

For this purpose, the mechanical joining or forming process is stopped, and the component of the feed head adapted to move the connecting element to make contact with the workpiece is fed to the workpiece (again) for the determination of a contact point of the connecting element on the workpiece as next method step. This component of the feed head which is adapted to move the connecting element to make contact with the workpiece in the joining or forming process will be referred to in this disclosure and the accompanying claims as the “carrier component.” For this purpose of determining a contact point of the connecting element, a corresponding, defined position of the feed head, for example starting or home position, is taken up and the carrier component is again moved in the direction of the workpiece. In this starting position, the component(s) for the feeding of the connecting element toward the workpiece can preferably be retracted, without changing the position of the robot arm or the feed head itself (for example for a joint).

By means of at least one suitable measuring device (for determining the position), in particular a device for measuring the travel of the carrier component, it can be determined during the feeding whether the connecting element contacts the workpiece with its tip within a tolerance. If the result lies within the tolerance range, an element is still located in the feed head. In contrast, if the result lies outside the tolerance range or no contact can be detected, no element is located in the feed head.

By carrying out the method step of locating the contact point (“finding”) again as described above, it is guaranteed that it can also be detected whether a connecting element has possibly been released from the feed head (and lies in the equipment area) in the “finding” or in particular “extruded hole formation” method steps carried out previously or is still located in the feed head after all.

Furthermore, it is even conceivable that a connecting element that has already partially penetrated into the workpiece and is fixed therein can be detected, because a contact point outside the tolerance range and shorter than the known screw length can be ascertained here.

In some embodiments of the invention, the determination (as to whether a connecting element is still located in the feed head) explained above takes place in a stage of the process before or up to a small penetration of the connecting element perhaps a penetration up to the point at which threads of the connecting element engage the workpiece (maximum unthreaded penetration). Later process stages, in which the connecting element has already penetrated further into the workpiece, are accordingly no longer taken into consideration for such a determination according to the invention.

Because a connecting element is released from the feed head or the corresponding holder after penetrating beyond a small extent and is for that reason firmly located in the workpiece, in this case it cannot happen that a connecting element, which needs to be removed for safety reasons, is left behind in the equipment area.

If it is only intended to rule out that connecting elements have been left behind in the equipment area, in this case unnecessary method steps (determining whether a connecting element is still located in the feed head and an ejection or ejection stroke) can be avoided and time can thus be saved. This error event can then preferably be recorded by a corresponding message and/or can trigger a corresponding alarm (for example “check connection or make a note before checking”).

In some embodiments of the invention, in the case where no connecting element is located in the feed head, the feed head is returned to a starting position and a new connecting element is loaded into the feed head or a loading stroke is carried out.

In this case, a message and/or alarm can additionally be logged and/or issued, that an unprocessed connecting element is located in the equipment area and is to be removed, for example manually.

In contrast, if it was determined that a connecting element is still located in the feed head, the process interrupted in the event of an error can be continued at the present location or a new process can be started or continued at another location (machining position).

In a particularly advantageous embodiment of the invention, the method step of feeding the connecting element to the workpiece for the determination of the contact point of the connecting element on the workpiece is effected without any rotational movement of the carrier component of the feed head.

In further embodiments of the invention, a device for carrying out the method explained above has a feed head with a receiver for a connecting element, in particular friction drilling screw, a carrier component, a drive arrangement, and a control unit for controlling a mechanical joining or forming process. Here, the control unit is configured such that in the event of an error in the process it carries out the process step or method step of causing the drive arrangement to move the carrier component toward the workpiece. From this movement the control unit ascertains whether connecting element contact with the workpiece is detected within a predefined permissible tolerance, in order to determine whether the connecting element is still located in the receiver of the feed head.

In additional embodiments of the invention, the feed head has a downholder and the carrier component comprises a shaft for transmitting a forward speed and torque to the connecting element. In these embodiments the control unit is configured such that the contact point of the connecting element (corresponding to the predefined permissible tolerance in the movement of the shaft) is determined in dependence on a determined contact point of the downholder on the workpiece and the position of the shaft relative to the downholder at its contact point.

A workpiece or several workpieces to be connected can advantageously be fixed in their position by the downholder before the connecting element contacts the workpiece. An undesired change in relative position can advantageously be prevented and the processing accuracy increased hereby.

These and other advantages and features of the invention will be apparent from the following description of representative embodiments, considered along with the accompanying drawings.

### BRIEF DESCRIPTION OF THE DRAWINGS

FIG. 1 is a side view of the front area of a feed head in longitudinal section.

FIG. 2 an example of a screw that has penetrated into a component without pilot hole.

FIG. 3 an example of a screw that has penetrated into a component with pilot hole.

FIG. 4 is a schematic representation of an apparatus according to aspects of the present invention.

### DESCRIPTION OF REPRESENTATIVE EMBODIMENTS

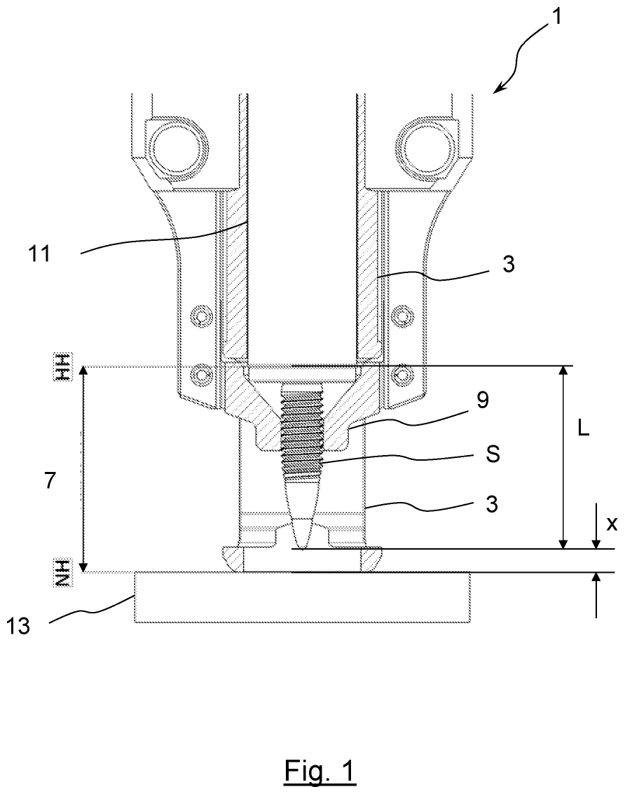

The feed head 1 of a screwing device represented in FIG. 1 preferably has a downholder 3 in the front area, which can be extended axially in the direction of a workpiece 13 (or 13′ in FIG. 3) for example via its own actuator (not shown in FIG. 1).

As can be seen in FIG. 1, the downholder 3 has already been extended to the extent that it has reached its contact point (downholder contact point) at which it makes contact with workpiece 13 to fix the workpiece 13 in position. The workpiece may, for example, include two metal sheets lying one on top of the other the thus the downholder contact may also press parts of the workpiece 13 together as part of fixing the workpiece 13 in position.

The feed head 1 has a shaft 11 which comprises the carrier component in this embodiment. At the tip of shaft 11 there is arranged a tool which is not represented in more detail. This tool, for example a Torx® bit, is engaged with the correspondingly formed head of a screw S shown in FIG. 1 retained in a loaded position on shaft 11.

In the example feed head 1, the screw S is shown secured in the feed head 1 by a receiver comprising two retaining elements 9. In this loaded position, the screw S is rotatable about its longitudinal axis. The retaining elements 9 may be configured to secure the screw S in the feed head 1 at least until the tip of the screw S contacts the workpiece 13.

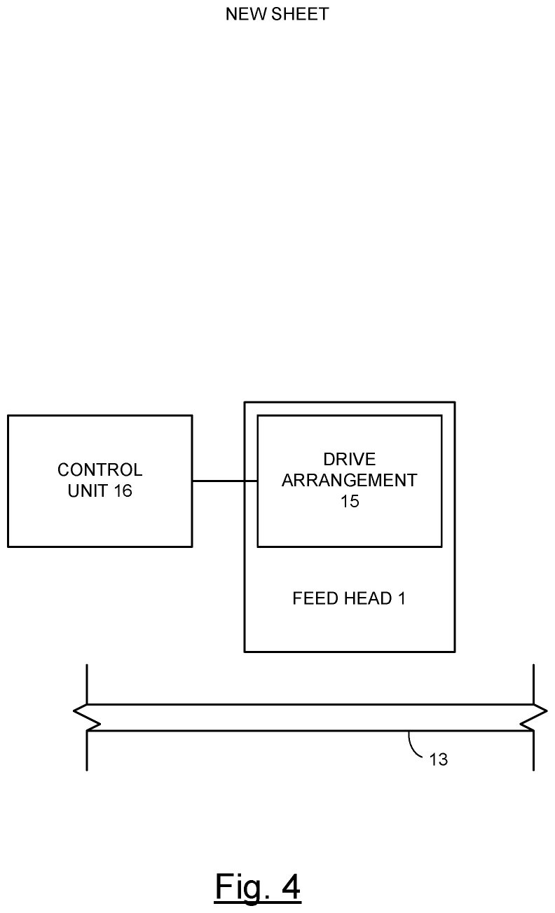

The shaft 11 can preferably be extended axially in the direction of the workpiece 13 (or 13′ in FIG. 3) via its own actuator independently of the downholder 3. This actuator, which is not shown in FIG. 3 will be described further below in connection with FIG. 4.

The actuator for shaft 11 and thus the shaft 11 itself, as well as the screw S arranged thereon, is preferably not advanced until after the downholder 3 has touched down or the contact point of the downholder 3 on the surface of the workpiece 13 (13′ in FIG. 3) has been reached and detected.

In a preferred embodiment, the positional difference 7 between downholder 3 and shaft 11, that is, the distance between the downholder contact point NH and the starting position HH of the shaft 11, which was determined by means of a travel measuring device not represented in more detail in the drawing, can be used in order to determine a contact point of the screw S or the tip thereof on the workpiece 13.

Starting from a starting position, in which with a defined position of the feed head 1 both downholder 3 and main cylinder 11 are retracted, the downholder 3 is extended to its contact point on workpiece 13 and the difference between downholder contact point NH and shaft 11 starting position HH is recorded as the positional difference 7.

Reaching the contact point of the downholder 3 on the workpiece 13 (or 13′ in FIG. 3) is detected by a corresponding measuring and evaluation device of the feed head 1, for example a travel measuring device (travel or stroke of the downholder 3 as a function of time) or a force or pressure measuring device, through the corresponding change in the detected values (travel, speed, acceleration, force, pressure, etc.).

For example, such a contact point of the downholder 3 can be determined by means of a travel measuring device, which measures the distance traveled by the downholder (downholder stroke). In the simplest case, the contact point of the downholder 3 is considered to be reached when no further distance is traveled or the travel is constant over time without a further change in a corresponding travel-time graph.

The distance from the downholder 3 contact point NH to the shaft 11 starting point HH (positional difference 7) is recorded by means of the travel measuring device.

Starting from this positional difference 7 minus the known length L of the screw S (without engagement area of the head which overlaps in length with the tool tip on shaft 11), the shaft 11 can be extended by the travel or stroke x, with the result that the tip of the screw S the surface of the workpiece 13 (or 13′ in FIG. 3) and thus the contact point of the screw S is reached.

The stroke x can be monitored here by a travel measuring device for the shaft 11, which measures the stroke of the shaft 11 relative to the feed head 1, as well as the downholder travel measuring device, which measures the stroke of the downholder relative to the feed head 1. It is of course also conceivable that the relative travel or stroke between downholder 3 and shaft 11 is measured starting from a starting position of both (retracted position) by means of a travel measuring device, in order to determine the stroke x for reaching the contact point of the screw S.

In each case, in the so-called first process stage of “finding”, the contact point of the screw S on the workpiece 13 (13′ in FIG. 3) is determined (or even directly detected), with the result that following this the second working step or the second process stage, the so-called “extruded hole formation”, is carried out.

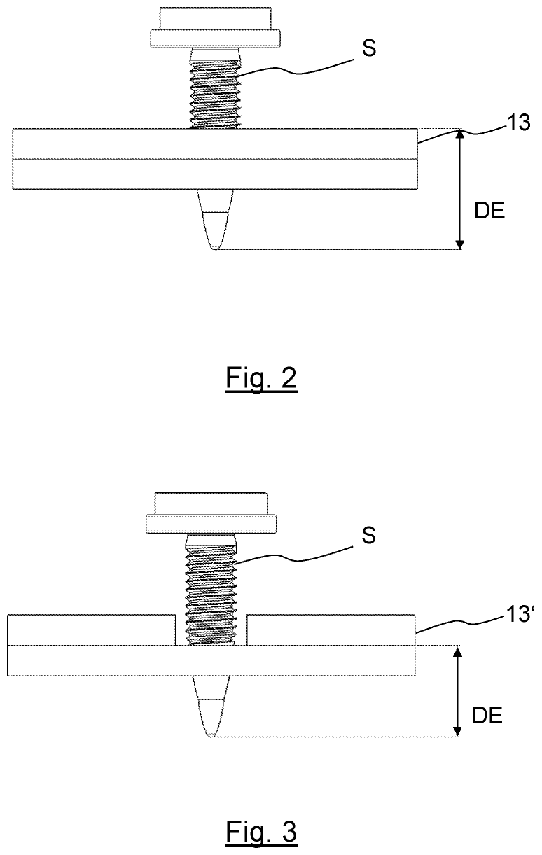

During the “extruded hole formation”, with a predefined rotational speed and feed force of the shaft 11, the screw tip penetrates up to a predefined penetration depth DE as represented in FIG. 2. The penetration depth DE of the extruded hole (starting from the contact point of the screw S) is prespecified depending on the tip geometry of the element and the thickness of the workpiece 13.

After the tip of the screw S has penetrated and the thread turns have been reached, the so-called “thread forming” is effected, in which the screw S forms a thread in the workpiece 13 and is screwed in until the screw head meets the surface (final tightening). In this phase, although the screw S leaves the feed head 1 or is no longer secured in it by the retainers 9, it has already penetrated so far into the workpiece 13, and is fixed therein, that there is no fear of losing the screw S.

In the finding phases or stages (up to contact of the screw S on the workpiece 13, 13′) and also the phase of first penetration (extruded hole formation), however, it cannot be ruled out in the event of a detected error that a screw S has fallen out of the feed head 1, thus is also not already located in the workpiece 13.

Such an error event occurs for example if, in the “finding” and “extruded hole formation” process stages or method steps, the desired actual projection (distance from screw to workpiece surface to reach the contact point of the screw) or the actual penetration depth DE is not reached or does not lie within a predefined tolerance, and the process is therefore aborted.

As represented in FIG. 3, if the workpiece 13′ and the method involve a screw connection with pilot hole for example, it can result, depending on the depth of the pilot hole and because of the correspondingly smaller penetration depth DE, in the retainers 9 opening and the screw S slipping out of the feed head 1.

If the workpiece 13 and the method involve a screw connection without pilot hole, as represented in FIG. 2, in the event of an error the screw S is then in all probability pulled back into the feed head 1, as the retainers 9 were mechanically unable to open. However, this is not guaranteed in each case, with the result that here too there is the possibility that the screw S slipped out of the feed head 1.

In each case, it can happen, in particular in the “extruded hole formation” stage in which the actual joining process begins and the workpiece 13, 13′ is penetrated, that the machining process has to be aborted in the event of an error and the screw S is no longer located in the feed head 1, thus in the worst case undesirably lies in the equipment area.

A corresponding error event can, as explained, occur for example if—depending on screw length—the carrier component stroke in relation to the downholder stroke does not reach the desired depth, a depth of for example 7 mm to 12 mm, in order to complete the “extruded hole formation” stage.

Furthermore, the screw S installation procedure can be aborted, for example in the “finding” stage, if the actual projection does not lie within the tolerance in the stage, or in the “extruded hole formation” stage, due to values falling below or above those permissible for the rotational speed of the shaft 11, the (feed) force, the torque, or the maximum time already being exceeded before the desired depth is reached, for example after 3 mm. Whether the retainers 9 are still mechanically locked and the screw S was pulled back into the feed head 1 is, however, difficult to detect in this case.

According to the invention, in the event of a detected error, in particular in the “finding” and “extruded hole formation” stages, thus when values fall below a predefined minimum or predefined maximum values are exceeded for travel, speed, acceleration of the actuators for the downholder 3 stroke and shaft 11 stroke, rotational speed and torque of the shaft 11, shaft 11 feed force, actual projection not within the tolerance, etc., it is detected whether a connecting element, for example friction drilling screw S, is still located in the feed head 1.

For this purpose, the aborted procedure is continued, preferably without changing the machining position (for the corresponding joint) of the feed head 1, in that a defined position (lifted off the workpiece) of the shaft 11 and optionally additionally a defined position (lifted off the workpiece) of the downholder 3, preferably the earlier starting position (retracted cylinders), is taken up.

Starting from this position, without ejection stroke for ejecting any screw S present and without loading a new screw S, the “finding” method step (determination of the contact point of the screw S) is carried out again.

If a contact point of the screw S on the workpiece 13, 13′ can be determined within a predefined tolerance range, it is thus guaranteed that a screw S is still located in the feed head 1.

In methods according to the invention, the repeated process of starting and carrying out the “finding” stage, can preferably be effected without rotational movement of shaft 11.

In each case, it can be detected on the basis of the known parameter of the screw length L whether the contact point still has the positional difference 7 (lying within a monitoring tolerance) determined in the previous stage and as a consequence the screw S is still located in the feed head or not.

More particularly, should the screw S no longer be located in the feed head 1, the shaft 11 (and shaft actuator) would then travel further than with the screw S in the feed head (further than the distance x shown in FIG. 1 as the positional difference 7 less the screw length L), and a contact point would not be determined within the predefined tolerance range.

Correspondingly, it can be determined with certainty whether a screw S is located in the feed head 1 and the operator knows whether or not they may need to remove a (lost) screw S from the equipment area.

The predefined tolerance range can optionally also be defined more broadly than the prespecified tolerance range for the above-named “finding” process stage described in connection with FIG. 1.

Should a contact point of the screw S not be detected until during a further feed travel beyond a contact point, in which a penetration depth DE is to be expected and of course before the shaft 11 contacts the workpiece, it can be concluded from this that the screw S is no longer located in the feed head 1 but rather in the workpiece 13, 13′ (albeit not necessarily at the desired penetration depth DE), but is not lying around in the equipment area.

The schematic representation of FIG. 4 shows the feed head 1 in relation to the workpiece 13. A drive arrangement 15 is associated with the feed head 1 and includes actuators (not shown separately) for both the shaft and downholder included in feed head 1 (11 and 3, respectively, in FIG. 1). A control unit 16 is shown in FIG. 4 for controlling the operation of the feed head 1 at least in accordance with the present invention. In particular, control unit 16 is configured to cause drive arrangement 15 to move the carrier component (shaft 11 in FIG. 1) toward the workpiece 12 in response to the detection of an error event as described above. The control unit 16 also ascertains whether a connecting element contact point is detected as described above within a predefined tolerance in the movement of the carrier component toward the workpiece 13.

Although the method according to the invention was described for a friction drilling screw in the above embodiment example, the method according to the invention is not limited thereto, but can be applied generally within mechanical joining and forming processes. Accordingly, the above-named screw S only represents a corresponding connecting element by way of example.

As used herein, whether in the above description or the following claims, the terms “comprising,” “including,” “carrying,” “having,” “containing,” “involving,” and the like are to be understood to be open-ended, that is, to mean including but not limited to. Also, it should be understood that the terms “about,” “substantially,” and like terms used herein when referring to a dimension or characteristic of a component indicate that the described dimension/characteristic is not a strict boundary or parameter and does not exclude variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

Any use of ordinal terms such as “first,” “second,” “third,” etc., in the following claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

The term “each” may be used in the following claims for convenience in describing characteristics or features of multiple elements, and any such use of the term “each” is in the inclusive sense unless specifically stated otherwise. For example, if a claim defines two or more elements as “each” having a characteristic or feature, the use of the term “each” is not intended to exclude from the claim scope a situation having a third one of the elements which does not have the defined characteristic or feature.

The above-described preferred embodiments are intended to illustrate the principles of the invention, but not to limit the scope of the invention. Various other embodiments and modifications to these preferred embodiments may be made by those skilled in the art without departing from the scope of the present invention. For example, in some instances, one or more features disclosed in connection with one embodiment can be used alone or in combination with one or more features of one or more other embodiments. More generally, the various features described herein may be used in any working combination.

### LIST OF REFERENCE CHARACTERS

1 feed head
3 downholder
7 positional difference
9 two retaining elements
11 shaft/carrier component
13 workpiece (for example consisting of two metal sheets lying one on top of the other)
13′ workpiece with pilot hole
15 drive arrangement
16 control unit
DE extruded hole penetration depth
L length of the screw
S screw
NH downholder contact point
HH shaft 11 starting position
x stroke of the shaft 11 up to the contact point of the screw S

1-10. (canceled)

11. A method for detecting a connecting element in a mechanical joining and forming process in which an error event has been identified, the method including:
(a) in response to the detection of an error event in a process of installing a connecting element on a workpiece at a first location, moving a carrier component of a feed head toward the workpiece; and
(b) determining whether a connecting element contact point is detected within a predefined permissible tolerance in the movement of the carrier component toward the workpiece in order to determine whether the connecting element is still located in a loaded position on the carrier component.

12. The method claim 11 wherein steps (a) and (b) of claim 1 are carried out only where the error event was identified before the carrier component reached a predefined distance from the workpiece corresponding to a maximum unthreaded penetration distance of the connecting element into the workpiece.

13. The method according to claim 11 wherein the connecting element contact point is detected via a measurement of travel of the carrier component in the course of the movement of the carrier component toward the workpiece.

14. The method of claim 11 further including, where the connecting element contact point is not detected within the predefined permissible tolerance, returning the feed head to a starting position and loading a new connecting element into the loaded position on the carrier component.

15. The method of claim 11 further including, where the connecting element contact point is not detected within the predefined permissible tolerance, issuing a message or alarm to indicate that an unprocessed connecting element is to be removed from an area of the process of installing the connecting element on the workpiece.

16. The method of claim 11 further including, where the connecting element contact point is detected within the predefined permissible tolerance, continuing the process of installing the connecting element on the workpiece.

17. The method of claim 11 further including, where the connecting element contact point is detected within the predefined permissible tolerance, starting a process of installing the connecting element at second location different from the first location.

18. The method of claim 11 wherein moving the carrier component of the feed head toward the workpiece is effected without any rotational movement of the carrier component.

19. An apparatus including:
(a) a feed head;
(b) a receiver connected to the feed head for receiving a connecting element in a loaded position on a carrier component of the feed head;
(c) a drive arrangement for moving the carrier component along a carrier component stroke in a mechanical joining or forming process sufficient to move the connecting element from a start position to a connected position on a workpiece; and
(d) a control unit for controlling the drive arrangement in the mechanical joining or forming process, the control unit being configured to
(i) in response to detection of an error event in the mechanical joining or forming process, cause the drive arrangement to move the carrier component toward the workpiece; and
(ii) ascertain whether a connecting element contact point is detected within a predefined permissible tolerance in the movement of the carrier component toward the workpiece.

20. The apparatus of claim 19 wherein:
(a) the feed head includes a downholder and the carrier component comprises a shaft for transmitting a forward speed and torque to the connecting element; and
(b) the control unit is configured such that the predefined permissible tolerance in the movement of the shaft toward the workpiece is determined in dependence on a determined contact point of the downholder on the workpiece and the position of the shaft relative to the determined contact point of the downholder on the workpiece.
